(19) United States
(12) Patent Application Publication
(10) Pub. No.: US 2012/0234993 A1
(43) Pub. Date: Sep. 20, 2012

(54) Device For Attaching A Handle To An Appliance Door

(75) Inventors: Robert M. Byrne, Lima, OH (US); Richard J. Hemmelgarn, Tipp City, OH (US); Dennis Hartke, Sidney, OH (US)

(73) Assignee: American Trim, LLC, Lima, OH (US)

(21) Appl. No.: 13/417,758

(22) Filed: Mar. 12, 2012

Related U.S. Application Data
(60) Provisional application No. 61/452,184, filed on Mar. 14, 2011.

(51) Int. Cl. F16M 13/02

(52) U.S. Cl. 248/201; 248/222.14

(57) ABSTRACT

A device is disclosed for attaching a handle to a compartment door for a home appliance. The device includes a stud with an annular groove mounted on the front of the compartment door and a bracket attached to the handle. The bracket is secured to the stud by means of a set screw adapted to be advanced through a threaded opening in the bracket into the groove and then into engagement with portions of the groove to complete the attachment.

This application claims priority to Application Ser. No. 61/452,184 filed Mar. 14, 2011, which is incorporated herein in its entirety.

### BACKGROUND OF THE INVENTION

1. Field of the Invention

This invention relates to handles for compartment doors on home appliances such as refrigerators and ovens and more particularly to a device for attaching a handle to a respective compartment door.

2. Description of the Related Art

Various types of home appliances such as refrigerators, ovens and the like require special doors to access compartments such as for food storage. These doors are typically hinged along one side so that they swing outwardly between open and closed positions about a vertical axis. To assist in this, a handle is usually provided on the side of the door opposite the hinges.

The length of the handle is particularly significant in the case of so-called “side-by-side” refrigerators where a full height refrigeration compartment with its own door is located next to a full height freezer compartment also with its own door. In view of this, a longer door handle is more convenient for users in that it accommodates people of all heights including children. As a result, the handle is usually attached at both of its ends preferably with the same type of mounting device.

One fairly common way to attach a handle to an appliance door is to extend fasteners through the door from the inside and then to secure the outwardly protruding ends of the fasteners to the handle such as by means of a threaded connector, This fastening technique is effective, however, the exposed fastener heads on the inside of the door are undesirable from an aesthetic point of view. Also, the installation of such devices is difficult and time consuming.

A more current fastening method uses fastening members such as studs mounted on the front of the door and means such as set screws for attaching the respective ends of the handle to the studs. A method of this type is shown and described in Kim U.S. App. Pub. No. US2009/0007385 A1.

Among the problems encountered with these prior art attachment methods are the risk of scratching the exterior finish of the door, the excessive time required for installation and the possibility of having a gap or gaps between the portion of the handle that fits against the door and the surface of the door itself.

Also, many of these prior art methods require a specially fabricated component for each particular size and shape of handle. This is a costly requirement and a need exists for an attachment device that is compatible with a variety of different types of handles and compartment doors.

The device of the present invention satisfies the requirements described above and affords other features and advantages heretofore not obtainable.

### SUMMARY OF THE INVENTION

By using the unique device of the invention, a handle for a compartment door on a home appliance may be quickly and securely attached to the door in a manner that provides an improved fit and appearance. In most cases, the opposite ends of the handle must both be attached to the door so two devices embodying the invention will be required. Since the devices are generally identical, only one such device will be described herein.

The device includes a stud with a central axis mounted on the compartment door and having a forward end that extends outwardly perpendicular to the exterior side of the door. The forward end of the stud has an annular groove formed therein defined by a floor, a rearward wall and a forward wall (i.e. furthest out from the door). The forward wall of the groove tapers outwardly from the floor to the outer surface of the forward end of the stud. Thus the forward wall has a frusto-conical shape.

The device further includes a bracket attached to the respective end of the handle, the bracket being adapted for operative engagement with the stud. The bracket has a relatively flat base with an opening therein of sufficient size to accommodate the stud which extends therethrough. When the bracket is in its assembled condition, the base is parallel to the front surface of the compartment door.

Also, the bracket has two outwardly extending legs located on opposite sides of the base and on opposite sides of the stud. One of the legs has a laterally projecting member at its outer end that extends into a portion of the annular groove. The other leg has a threaded opening with a thread axis that extends toward the stud but is off set from the central axis of the stud. In other words, the thread axis does not intersect the central axis of the stud.

The threaded opening in the respective leg receives a set screw that is threaded through the opening toward the stud and into the annular groove. As the set screw is advanced through the threaded opening, its front end engages the tapered forward wall of the groove which, as described above, has a frusto-conical shape. Further advancing of the set screw draws the laterally projecting member on the other side of the stud further into the groove. Thus the turning of the set screw serves to apply equal and opposite forces to the stud.

This advancing of the set screw also produces a “ramp” effect that urges the bracket and handle toward the surface of the compartment door and assures that no gaps exist between the respective end of the handle and the door. Also, the further advance of the set screw produces an additional advantageous result. More particularly, the bracket is urged in a direction relative to the stud such that an edge portion of the opening in the base engages the outer surface of the stud. This contact combined with the contact between the set screw and the lateral member with the groove portions of the stud produces a firm connection between the handle and the compartment door.

In accordance with one aspect of the invention, the opening in the base is generally circular and has at least one notch formed in an edge portion thereof. The notch is located along a line that bisects the circular opening and extends between and equidistant from the two legs of the bracket. The notch and adjacent edges of the opening define two points of contact between the base of the bracket and the side surface of the stud.

In an alternate form of the invention, the laterally projecting member of the respective leg of the bracket is provided with a curved (concave) cut out portion facing the stud adjacent the annular groove. This permits the bracket to accommodate larger diameter studs.

In another alternate form of the invention, the laterally projecting member is eliminated from its respective leg so that the resulting leg is essentially a mirror image of the opposite leg. Accordingly, the resulting leg has a threaded opening that receives another set screw that is threaded through the threaded opening and into the annular groove. With this arrangement two set screws are advanced into the annular groove but from opposite sides and in opposite directions to accomplish the attachment process.

### BRIEF DESCRIPTION OF THE DRAWINGS

FIG. 1 is an isometric view showing a refrigerator with a freezer compartment and a refrigeration compartment located side by side and with separate vertically hinged doors, the doors having handles attached in accordance with the invention.

FIG. 2 is an exploded perspective view showing the principal components of the device of the invention.

FIG. 3 is a plan view showing the device of the invention as shown in FIG. 2 mounted in an end of a door handle (shown in section) with parts broken away and shown in section for the purpose of illustration.

FIG. 4 is a side elevation of the device of FIGS. 2 and 3, taken on the line 4-4 of FIG. 3, showing the respective end of the door handle in section and with parts of the device broken away for the purpose of illustration.

FIG. 5 is a sectional view taken on the line 5-5 of FIG. 3 and showing the stud of the invention in elevation.

FIG. 6 is an exploded perspective view showing an alternate form of the device of the invention.

FIG. 7 is an exploded perspective view showing still another alternate form of the device of the invention.

### DESCRIPTION OF THE PREFERRED EMBODIMENT

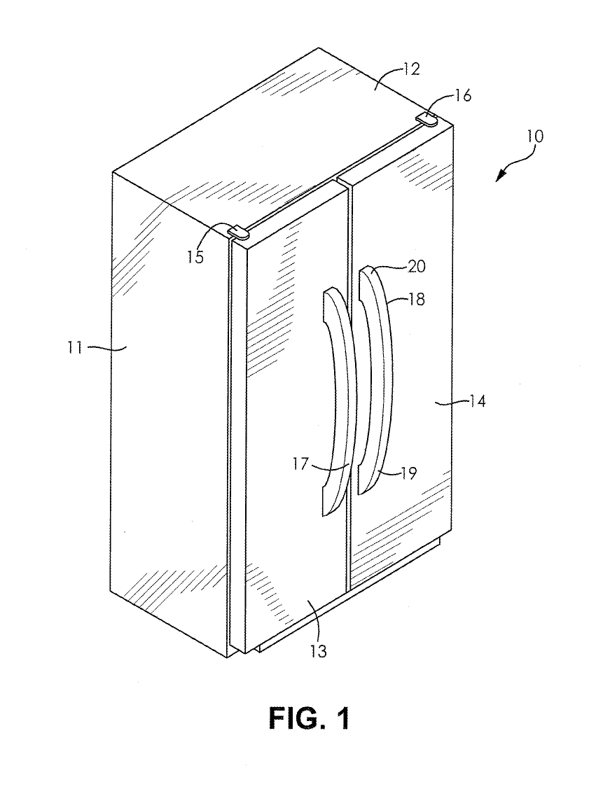

Referring more particularly to the drawings and initially to FIG. 1, there is shown a refrigerator 10 that is typical of the type of home appliance with which the device of the invention is used. As a matter of convenience, only the refrigerator 10 will be used for the purpose of showing and describing the invention, even though the invention is applicable to many other types of home appliances, including but not limited to ovens, dishwashers, microwaves and ranges.

The refrigerator 10 has side-by-side compartments including a freezer compartment space 11 and a refrigerator compartment 12. Each compartment has its own door 13 and 14 respectively. The doors 13 and 14 are hinged along their outer sides for swinging movement about their respective vertical hinge axes between open and closed positions. Two of the hinges (15 and 16) are shown.

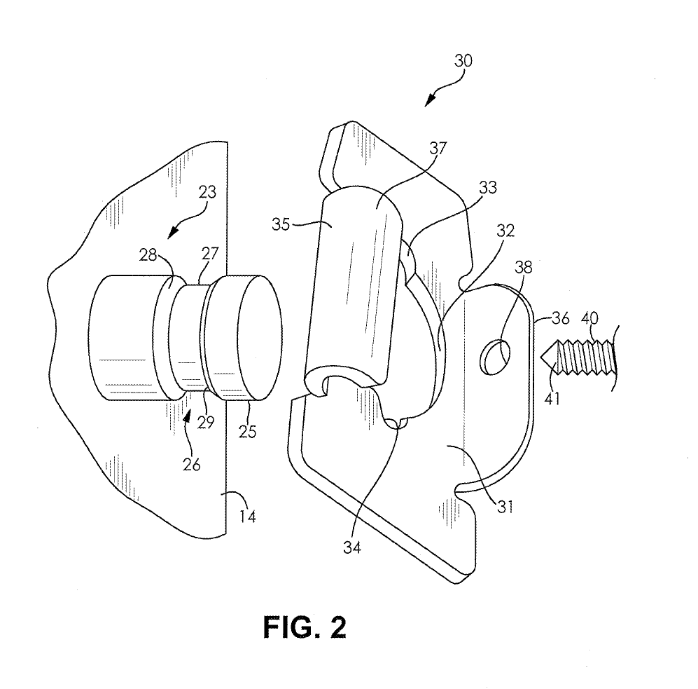

Each door 13 and 14 has a handle 17 and 18 respectively, secured on its inward side to a door, the handles being identical. Each handle is connected to its respective door, 13 and 14, at its opposite ends 19 and 20. Since the handle end portions are essentially identical, only the end portion 20 will be described. The end portion 20 has a recess 21 formed therein to receive the attaching device which is best shown in FIGS. 2 through 5.

The attaching device includes a mounting stud 23 with a threaded inner end 24 that is secured to the door 14 using any one of many well known techniques. The stud 23 also has a forward end 25 provided with an annular groove 26 defined by a floor 27, of generally cylindrical form, a rearward wall 28 (the wall closest to the door) and a forward wall 29. The forward wall 29 tapers outwardly from the floor 27 to the outer surface of the forward end 25 of the stud 23 so that the wall 29 has a frusto-conical shape.

The device further includes a bracket 30 attached to the upper end portion 20 of the handle 18 and located generally within the recess 21. The bracket 30 typically comprises a stamped sheet metal component and is best shown in FIG. 2. The bracket 30 is adapted for operative engagement with the stud 23 and may be secured to the end portion 20 of the handle by any suitable means such as welding, mechanical fastening or adhesive.

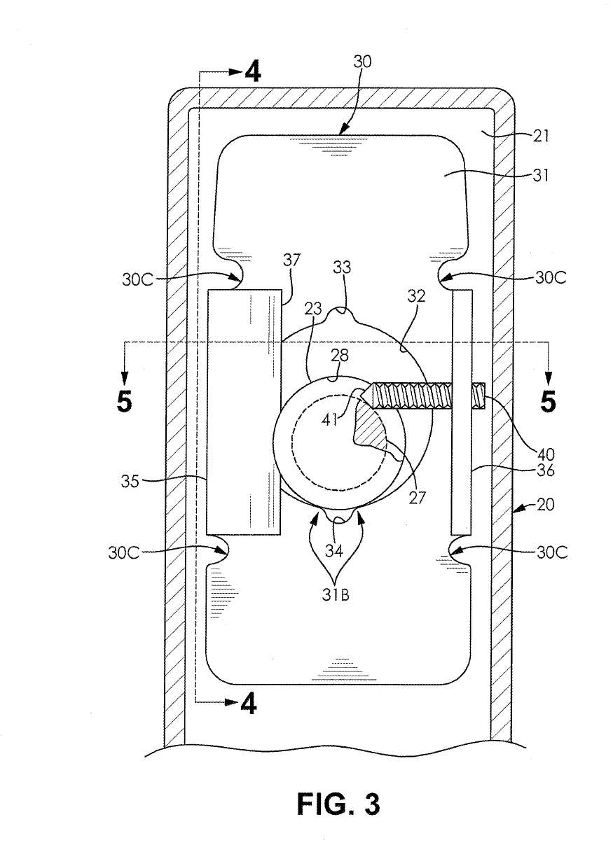

The bracket 30 has a relatively flat base 31 with a central opening 32 of sufficient size to accommodate the forward end 25 of the stud 23, which extends there-through. When the bracket 30 is in assembled condition as shown in FIGS. 3, 4 and 5, the base 31 is parallel to the front face of the compartment door 14.

The opening 32 in the base 31 is generally circular and has two diametrically opposed notches 33 and 34 formed in respective edge portions. The notches 33 and 34 are generally semi-circular and each one defines with its respective edge portion of the opening 32, two contact points that may be engaged with the forward end 25 of the stud 23 in a manner to be described below.

The bracket 30 also has two legs 35 and 36 that extend outwardly from the base 31. The legs are located on opposite sides of the opening 32 and on opposite sides of the stud 23. Preferably, semi-circular indents 30c, as best seen in FIG. 3, are included in the bracket base 31 at each end of the legs, to facilitate the formation of legs 35 and 36 without any crack formation. Bracket 30 may be formed using various techniques and materials, but preferably, it is stamped and formed from low carbon steel.

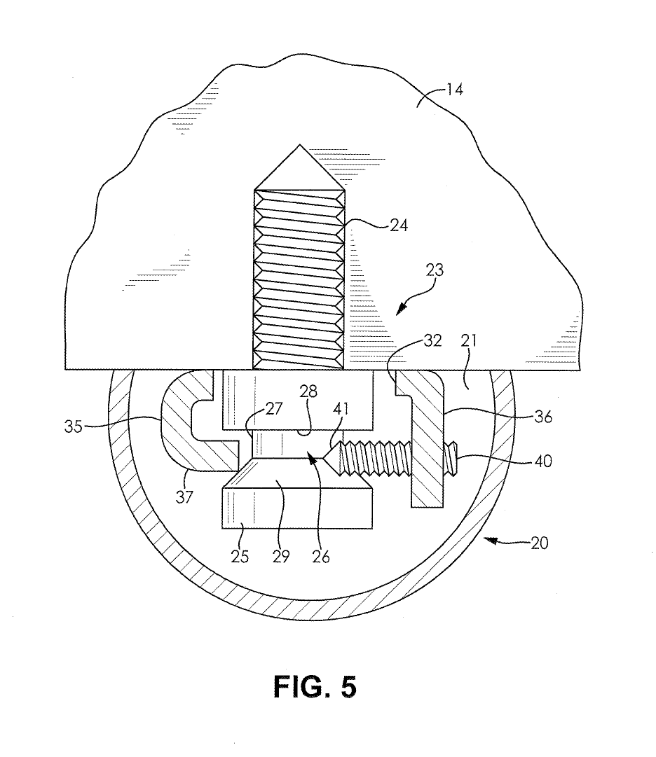

The leg 35 has a laterally projecting flange 37 that extends into a portion of the annular groove 26 (see FIGS. 3 and 5). The other leg 36 has a threaded opening 38 formed therein, the opening having a thread axis that extends toward the stud 23 but is offset from the central axis of the stud 23 as best shown in FIG. 3. In other words, the thread axis does not intersect the central axis of the stud.

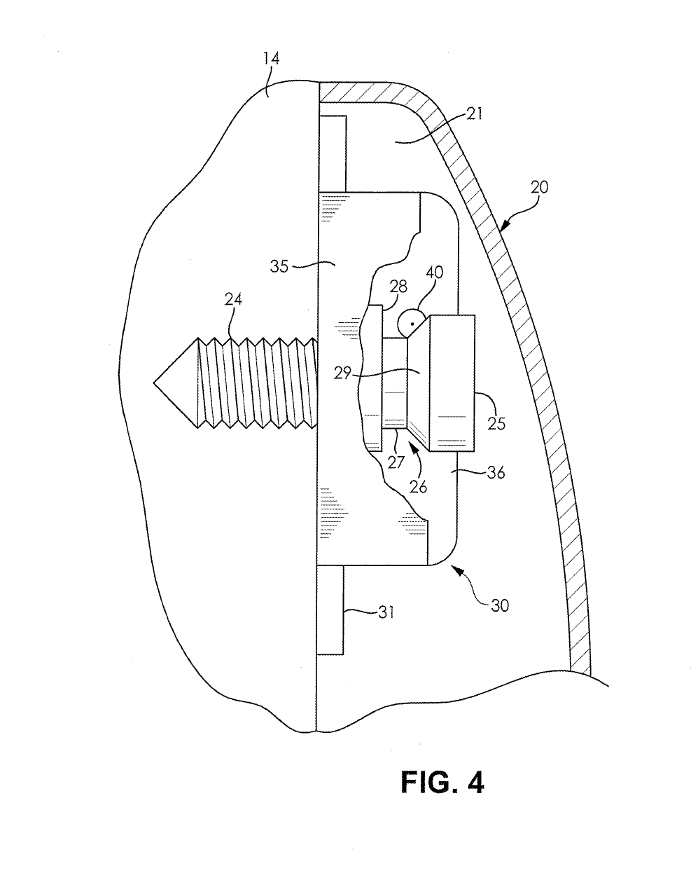

The threaded opening 38 receives a set screw 40 that is threaded through the opening and advanced toward and into the annular groove 26. As the set screw is further advanced, its front end 41 engages the tapered forward wall 29 as shown in FIGS. 4 and 5. This engagement produces equal and opposite forces that move both the flange member 37 and the set screw 40 into the groove 26 until a limit position is reached.

This advancing movement of the set screw 40 and flange member 37 also produce a “ramp” effect due to the tapered shape of the forward wall 29, so as to urge the bracket 30 and handle end 20 toward the surface of the compartment door 14. This assures a tight fit between the mating surfaces of the handle end portion 20 and the front face of the compartment door 14.

As the set screw is further advanced, the bracket 30 is urged in a direction relative to the stud 23 such that an edge portion of the circular opening 32 in the base 31 engages the stud as shown in FIG. 3. This contact occurs at the location of the notch 34 and adjacent to the edges of the opening 32 (the area generally indicated at 31b in FIG. 3), so that two points of contact are provided. Accordingly, this condition combined with the contact between the set screw 40 and the lateral portion of flange member 37 with portions of the groove 26 produces a firm connection between the handle 18 and the compartment door 14 and affords superior impact resistance and resistance to pull force.

It will be appreciated, that depending upon the size of the stud 25, and even the stud configuration, and the spacing of the stud on the appliance, upon tightening set screw 40, the stud could engage the area around notch 33 instead of the area in notch 34 as shown in FIG. 3. Thus, the provision of a pair of notches 33 and 34 provides a degree of flexibility relative to the size, spacing and configuration of the studs being used.

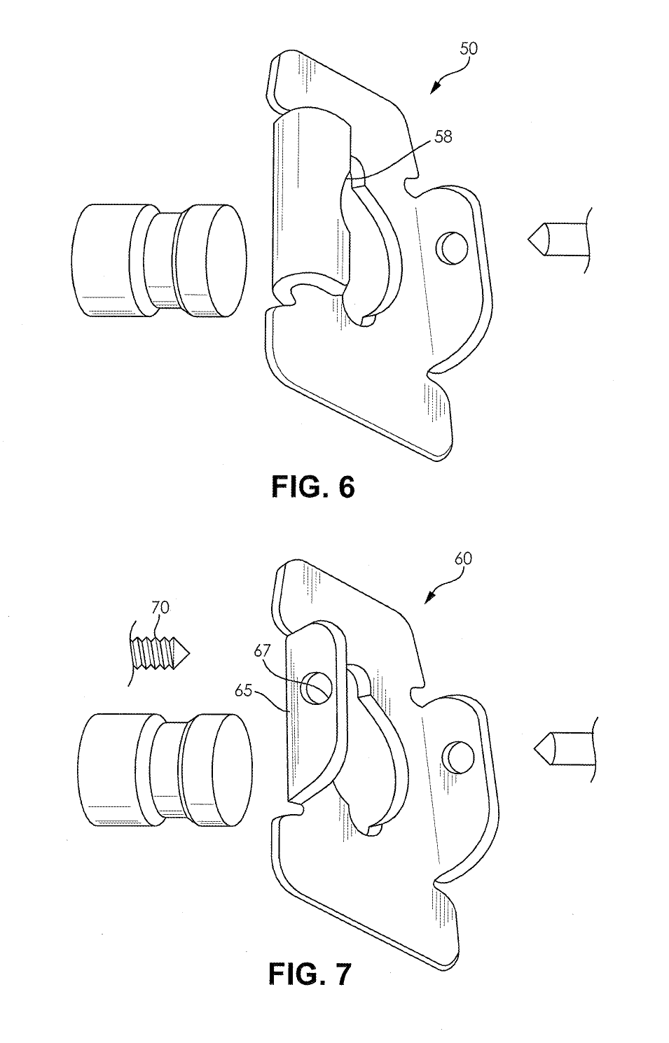

FIG. 6 shows an alternate form 50 of the invention wherein the laterally projecting member of the respective leg is provided with a curved cut out 58 in the area adjacent the annular groove in the stud. This permits the bracket to accommodate larger diameter studs.

FIG. 7 shows another alternate form 60 of the invention wherein the laterally projecting member is eliminated so that the resulting leg 65 is essentially a mirror image of the opposite leg. Accordingly the resulting leg 65 has a threaded opening 67 that receives another set screw 70 that is positioned to be advanced into the annular groove. With this arrangement, both set screws are advanced to complete the attachment process.

The device thus described provides among other advantages, a bracket design that offers superior durability and a low cost of fabrication. Also the bracket can be readily adapted to a wide variety of handle sizes and configurations.

While the invention has been shown and described with respect to specific embodiments thereof, this is intended for the purpose of illustration rather than limitation and other variations and modifications of the specific embodiments herein shown and described will be apparent to those skilled in the art all within the spirit and scope of the invention. Accordingly, the patent is not to be limited in scope and effect to the specific embodiments shown and described, or in any other way that is inconsistent with the extent to which the progress in the art has been advanced by the invention.

What is claimed:

1. A device for attaching a handle to an appliance door, said device comprising:
a stud with a central axis, mounted on and extending outwardly from the front of said door, said stud having an annular groove formed therein,
a bracket attached to said handle and having a base defining an opening adapted to receive said stud, said bracket having two legs extending outwardly from said base on opposite sides of said opening and on opposite sides of said stud, one of said legs having a laterally projecting member adapted to extend into a first portion of said groove and the other leg having a threaded opening formed therein with a thread axis that extends laterally toward said stud and that is off set from said central axis of said stud, and
a threaded element received in said threaded opening and adapted to be threadedly advanced toward said groove,
whereby, said threaded element, when advanced, engages a second portion of said groove, draws said projecting member into engagement with said first portion of said groove and urges an edge portion of said opening in said base into engagement with a surface portion of said stud.

2. A device as defined in claim 1 wherein said threaded element is a set screw.

3. A device as defined in claim 2 wherein said set screw has a conically shaped front end.

4. A device as defined in claim 1 wherein said stud has a cylindrically shaped outer surface.

5. A device as defined in claim 4 wherein said annular groove is defined by a generally cylindrical floor, a rearward wall and a forward wall furthest from said door, that tapers outwardly from said floor to said cylindrically shaped outer surface of said stud so as to define a frusto-conical surface.

6. A device as defined in claim 5 wherein both a front end of said threaded element and said laterally projecting member engage said frusto-conical forward wall of said groove so that the advance of said threaded element urges said handle into tight engagement with the exterior surface of said door.

7. A device as defined in claim 1 wherein said stud has a threaded inner end for mounting to said door.

8. A device as defined in claim 1 wherein said opening in said base is generally circular and centrally located in said base.

9. A device as defined in claim 8 wherein said base has at least one notch formed in an edge portion of said opening, said notch being located along a line extending across said opening between said legs and equidistant from said legs; whereby said threaded element, when advanced, engages a second portion of said groove, draws said projecting member into engagement with said first portion of said groove and urges said notch in said edge portion into engagement with a surface portion of said stud thereby creating two points of contact between said base and said stud.

10. A device as defined in claim 1 wherein said base has semi-circular indents in a peripheral edge portion of said base located at each side of an end of said legs.

11. A device as defined in claim 1 wherein said laterally projecting member has a concave cut out portion facing said stud and adjacent said annular groove in said stud.

12. A device as defined in claim 1 wherein said laterally projecting member comprises another threaded element and said respective leg has a threaded opening formed therein with a thread axis that extends laterally toward said stud and that is off set from said central axis of said stud.

13. A device as defined in claim 1 wherein said bracket comprises stamped sheet metal.

14. A home appliance having a compartment door, a handle for said door and a device for attaching said handle to said door, said device comprising:
a stud with a central axis, mounted on and extending outwardly from the front of said door, said stud having an annular groove formed therein,
a bracket attached to said handle and having a base defining an opening adapted to receive said stud, said bracket having two legs extending outwardly from said base on opposite sides of said opening and on opposite sides of said stud, one of said legs having a laterally projecting member adapted to extend into a first portion of said groove and the other leg having a threaded opening formed therein with a thread axis that extends laterally toward said stud and that is off set from said central axis of said stud, and
a threaded element received in said threaded opening and adapted to be threadedly advanced toward said groove,
whereby, said threaded element, when advanced, engages a second portion of said groove, draws said projecting member into engagement with said first portion of said groove and urges an edge portion of said opening in said base into engagement with a surface portion of said stud.

15. A home appliance as defined in claim 12 comprising two devices for attaching said handle to said door.

16. A home appliance as defined in claim 14 wherein said threaded element is a set screw.

17. A home appliance as defined in claim 16 wherein said set screw has a conically shaped front end.

18. A home appliance as defined in claim 14 wherein said stud has a cylindrically shaped outer surface.

19. A home appliance as defined in claim 18 wherein said annular groove is defined by a generally cylindrical floor, a rearward wall and a forward wall furthest from said door, that tapers outwardly from said floor to said cylindrically shaped outer surface of said stud so as to define a frusto-conical surface.

20. A home appliance as defined in claim 19 wherein both a front end of said threaded element and said laterally projecting member engage said frusto-conical forward wall of said groove so that the advance of said threaded element urges said handle into tight engagement with the exterior surface of said door.

21. A home appliance as defined in claim 14 wherein said stud has a threaded inner end for mounting to said door.

22. A home appliance as defined in claim 14 wherein said opening in said base is generally circular and centrally located in said base.

23. A home appliance as defined in claim 22 wherein said base has at least one notch formed in an edge portion of said opening, said notch being located along a line extending across said opening between said legs and equidistant from said legs; whereby said threaded element, when advanced, engages a second portion of said groove, draws said projecting member into engagement with said first portion of said groove and urges said notch in said edge portion into engagement with a surface portion of said stud thereby creating two points of contact between said base and said stud.

24. A home appliance as defined in claim 14 wherein said base has semi-circular indents in a peripheral edge portion of said base located at each side of an end of said legs.

25. A home appliance as defined in claim 14 wherein said laterally projecting member has a concave cut out portion facing said stud and adjacent said annular groove in said stud.

26. A home appliance as defined in claim 14 wherein said laterally projecting member comprises another threaded element and said respective leg has a threaded opening formed therein with a thread axis that extends laterally toward said stud and that is off set from said central axis of said stud.

27. A home appliance as defined in claim 14 wherein said bracket comprises stamped sheet metal.

28. A home appliance having a storage compartment, a door for said storage compartment, a handle for said door and a device for attaching said handle to said door, said device comprising:
a stud with a central axis mounted on and extending outwardly from the front of said door, said stud having an annular groove formed therein,
a bracket attached to said handle and having a base defining an opening adapted to receive said stud, said a bracket having two legs extending outwardly from said base on opposite sides of said opening and on opposite sides of said stud, one of said legs having a laterally projecting member adapted to extend into a first portion of said groove and the other leg having a threaded opening formed therein with a thread axis that extends laterally toward said stud and that is off set from said central axis of said stud, and
a threaded element received in said threaded opening and adapted to be threadedly advanced toward said groove,
whereby, said threaded element, when advanced, engages a second portion of said groove, draws said projecting member into engagement with said first portion of said groove and urges an edge portion of said opening in said base into engagement with a surface portion of said stud.

29. A home appliance as defined in claim 28 comprising two devices for attaching said handle to said door.

30. A device as defined in claim 28 wherein said threaded element is a set screw.

31. A device as defined in claim 30 wherein said set screw has a conically shaped front end.

32. A device as defined in claim 28 wherein said stud has a cylindrically shaped outer surface.

33. A device as defined in claim 32 wherein said annular groove is defined by a generally cylindrical floor, a rearward wall and a forward wall furthest from said door, that tapers outwardly from said floor to said cylindrically shaped outer surface of said stud so as to define a frusto-conical surface.

34. A device as defined in claim 33 wherein both a front end of said threaded element and said laterally projecting member engage said frusto-conical forward wall of said groove so that the advance of said threaded element urges said handle into tight engagement with the exterior surface of said door.

35. A device as defined in claim 28 wherein said stud has a threaded inner end for mounting to said door.

36. A device as defined in claim 28 wherein said opening in said base is generally circular and centrally located in said base.

37. A device as defined in claim 36 wherein said base has at least one notch formed in an edge portion of said opening, said notch being located along a line extending across said opening between said legs and equidistant from said legs; whereby said threaded element, when advanced, engages a second portion of said groove, draws said projecting member into engagement with said first portion of said groove and urges said notch in said edge portion into engagement with a surface portion of said stud thereby creating two points of contact between said base and said stud.

38. A device as defined in claim 28 wherein said base has semi-circular indents in a peripheral edge portion of said base located at each side of an end of said legs.

39. A device as defined in claim 28 wherein said laterally projecting member has a concave cut out portion facing said stud and adjacent said annular groove in said stud.

40. A device as defined in claim 28 wherein said laterally projecting member comprises another threaded element and said respective leg has a threaded opening formed therein with a thread axis that extends laterally toward said stud and that is off set from said central axis of said stud.

41. A device as defined in claim 28 wherein said bracket comprises stamped sheet metal.

42. A device as defined in claim 28 wherein said home appliance is a refrigerator.

43. An appliance including at least one mounting bracket assembly for a handle of an appliance door, said appliance comprising a door for selectively opening/closing a compartment of the appliance; a door-handle attached on a front surface of the door; a handle fixture, a stud of which one end mounted to the door and the other end is inserted into the bracket assembly, said other end of the stud including an annular groove; said bracket assembly being mounted in the handle and having a base, defining an opening adapted to receive said stud, that abuts the door and outwardly extending legs located on opposite sides of the base and on opposite sides of the stud, one of the legs includes a laterally projecting member at its outer end that extends into a portion of the annular groove formed in the stud, the other leg having a threaded opening with a thread axis that extends toward the stud but is off set from the central axis of the stud, a threaded element received in said threaded opening.
